(19) United States
(12) Patent Application Publication
(10) Pub. No.: US 2005/0156950 A1
(43) Pub. Date: Jul. 21, 2005

(54) Display apparatus and control method thereof

(75) Inventors: Sung-hwan Jang, Seongnam-si (KR); Kil-soo Park, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/009,553

(22) Filed: Dec. 13, 2004

(30) Foreign Application Priority Data
Dec. 13, 2003 (KR) 2003-90922

(51) Int. Cl. G09G 5/10

(52) U.S. Cl. 345/690

(57) ABSTRACT

A display apparatus having a displayer which displays a picture and a brightness adjuster which adjusts a brightness of the displayer, including: an optical sensor detecting circumferential brightness; and a controller calculating criterion brightness data of the displayer on a basis of the circumferential brightness, and calculating brightness data of the displayer according to a variation of the circumferential brightness on a basis of the criterion brightness data so as to control the brightness adjuster to adjust the brightness of the displayer according to the brightness data.

### CROSS-REFERENCE TO RELATED APPLICATION

This application claims the benefit of Korean Patent Application No. 2003-0090922, filed Dec. 13, 2003, in the Korean Intellectual Property Office, the disclosure of which is incorporated herein by reference.

### BACKGROUND OF THE INVENTION

1. Field of the Invention

The present invention relates to a display apparatus and a control method thereof, and more particularly, to a display apparatus and a control method thereof capable of adjusting brightness of the display apparatus on a basis of actual circumferential brightness.

2. Description of the Related Art

A brightness of a display apparatus that a user practically recognizes is greatly affected by circumferential (i.e., surrounding environmental) brightness. In other words, a user perceives a greater brightness of the display apparatus is when he/she is in darkness than when he/she is in brightness, even if the actual output brightness of the display is constant. Accordingly, the display apparatus stores specified criterion brightness data inside the apparatus, and the brightness of the display apparatus is adjusted according to the circumferential brightness on a basis of the stored data. In other words, the display apparatus outputs maximum brightness when the circumferential brightness detected by an optical sensor exceeds a particular brightness corresponding to the criterion brightness data, and reduces the brightness down from the maximum brightness when the circumferential brightness is below the particular brightness.

Accordingly, with the specified criterion brightness data as a basis, the output brightness of the display apparatus is decreased when the environment is darkened, and the output brightness of the display apparatus is increased when the environment is brightened.

Herein, in a case that the actual circumferential brightness of the display apparatus is identical to or above the particular brightness corresponding to the specified criterion brightness data, the display apparatus outputs the maximum brightness on a basis of the criterion brightness data. Also, in a case that the circumferential brightness falls below the particular brightness, the display apparatus decreases the output brightness.

However, in a case that the actual circumferential brightness is below the particular brightness corresponding to the criterion brightness data, such as when the user uses the display apparatus mainly at night or in a workplace darker than a common work workplace, the display apparatus cannot output the maximum brightness corresponding to an actual environment because the display apparatus outputs the maximum brightness on a basis of the specified criterion brightness data. Accordingly, the user always has to use the display apparatus with the brightness darker than the maximum brightness.

### BRIEF SUMMARY

Accordingly, it is an aspect of the present invention to provide a display apparatus and a control method thereof capable of adjusting brightness on a basis of actual circumferential brightness.

The foregoing and other aspects of the present invention are achieved by providing a display apparatus having a displayer which displays a picture and a brightness adjuster which adjusts a brightness of the displayer, including: an optical sensor detecting circumferential brightness; and a controller calculating criterion brightness data of the displayer on a basis of the circumferential brightness, and calculating brightness data of the displayer according to a variation of the circumferential brightness on a basis of the criterion brightness data so as to control the brightness adjuster to adjust the brightness of the displayer according to the brightness data.

The criterion brightness data of the displayer may have an upper limit and a lower limit, and the controller may adjust the brightness of the displayer on a basis of criterion data of the upper limit when the criterion brightness data exceeds the upper limit and on the basis of criterion data of the lower limit when the criterion brightness data is below the lower limit.

The criterion brightness data may be data with which the displayer outputs maximum brightness.

The controller may calculate the criterion brightness data on a basis of an average value of the circumferential brightness detected during a specified time.

According to another aspect of the present invention, the above and other aspect may be achieved by providing a control method of a display apparatus having a displayer which displays a picture and a brightness adjuster which adjusts brightness of the displayer, including: detecting circumferential brightness; calculating a criterion brightness data on a basis of the detected circumferential brightness; calculating brightness data according to a variation of the circumferential brightness on a basis of the criterion brightness data; and adjusting the brightness of the displayer with the brightness adjuster according to the calculated brightness data.

The criterion brightness data of the displayer may have an upper limit and a lower limit, and the controller may adjust the brightness of the displayer on a basis of criterion data of the upper limit when the criterion brightness data exceeds the upper limit and on the basis of criterion data of the lower limit when the criterion brightness data is below the lower limit.

The criterion brightness data may be data with which the displayer outputs maximum brightness.

The controller may calculate the criterion brightness data on a basis of an average value of the circumferential brightness detected during a specified time.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a block diagram of a display apparatus according to an embodiment of the present invention;

FIG. 2 is an example of the display apparatus of FIG. 1;

FIG. 3 is a graph comparing brightness of a conventional display apparatus with a fixed criterion brightness data and that of a display apparatus with a variable criterion brightness data;

FIG. 4 is a control flowchart of the display apparatus in FIG. 1.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

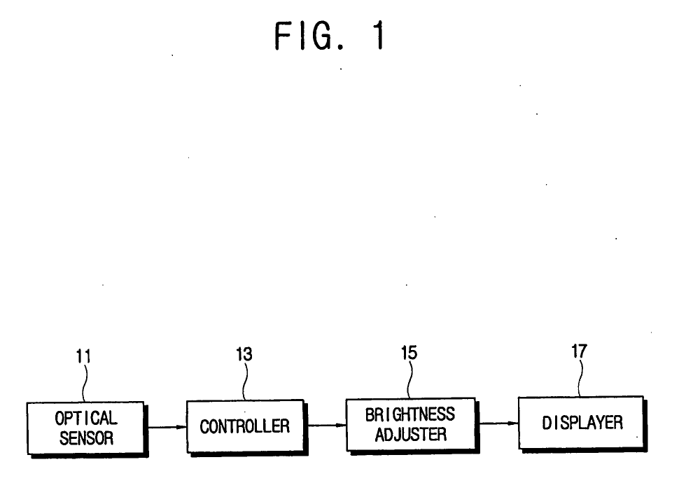

As shown in FIG. 1, a display apparatus according to an embodiment of the present invention comprises a displayer 17 displaying a picture, a brightness adjuster 15 adjusting brightness of the displayer 17, an optical sensor 11, and a controller 13.

The optical sensor 11 detects circumferential brightness.

The controller 13 calculates criterion brightness data of the displayer 17 on a basis of the circumferential brightness detected by the optical sensor 11. Also, the controller 13 calculates brightness data of the displayer 17 according to variation of the circumferential brightness on a basis of the calculated criterion brightness data. The controller 13 controls the brightness adjuster 15 to adjust the brightness of the displayer 17 on a basis of the brightness data.

The criterion brightness data is determined as data on which the display apparatus outputs the maximum brightness.

Accordingly, the controller 13 controls the brightness adjuster 15 to output the maximum brightness of the displayer 17 on a basis of the criterion brightness data, in a case when the circumferential brightness detected by the optical sensor 11 is identical to or above the particular brightness corresponding to the criterion brightness data.

The controller 13 calculates the brightness data that reflects the variation of the circumferential brightness on a basis of the criterion brightness data, when the circumferential brightness detected by the optical sensor 11 is reduced. As an example, the controller 13 may calculate the brightness data linearly reduced by as much as the variation of the circumferential brightness on a basis of the criterion brightness data. Also, the controller 13 controls the brightness adjuster 15 to adjust the brightness of the displayer 17 on a basis of the brightness data that reflects the variation of the circumferential brightness.

The controller 13 calculates the criterion brightness data by calculating an average value of the circumferential brightness detected by the optical sensor 11 during a specified time.

To enable the controller 13 to calculate the criterion brightness data, the controller 13 may have, for example, a storage part storing a sampling time during which the optical sensor 11 extracts samples out of the detected circumferential brightness, the number of samples extracted out of the circumferential brightness, and a sampling period with which the samples are extracted out of the circumferential brightness for updating the brightness data. Also, those data are storable in a separate memory.

The display apparatus further comprises an input part so that the user can store the sampling time, the number of samples, the sampling period in the storage part in the controller 13 or the separate memory using the input part.

The controller 13 calculates the average value of the circumferential brightness corresponding to the number of samples during the sampling time at every sampling period, and updates the criterion brightness data.

As an example, if the user determined the sampling period to be 1 hour, the sampling time to be 30 seconds, and the number of samples to be 10, the controller 13 begins updating the criterion brightness data every 1 hour. Herein, the controller 13 calculates the average value by sampling 10 circumferential brightness samples for 30 seconds with a period of 3 seconds or a period added with additional value.

A method in which the controller 13 calculates the criterion brightness data on a basis of the circumferential brightness detected by the optical sensor 11 is not limited to a method of calculating the average value of the circumferential brightness detected by the optical sensor 11 during the specified time. Rather, it is contemplated that a new criterion brightness data can be calculated by adding the brightness data corresponding to the current circumferential brightness to former criterion brightness data stored previously in the storage part of the controller 13 or in the separate memory. Also, various methods can be employed to calculate the criterion brightness data that reflects the actual circumferential brightness.

The criterion brightness data has an upper limit and a lower limit. The upper and lower limits are stored in the storage part of the controller 13 or in the separate memory.

The controller 13 sets the upper limit or the lower limit as the criterion brightness data in a case that the criterion brightness data calculated in the various methods are above the upper limit or below the lower limit. Also, the controller 13 controls the brightness adjuster 15 to output the maximum brightness if the circumferential brightness is above the particular brightness corresponding to the criterion brightness data. If the circumferential brightness is reduced, the brightness data that reflects the variation of the circumferential brightness is calculated on a basis of the criterion brightness data. Also, the controller 13 controls the brightness adjuster 15 to adjust the brightness of the displayer 17 on a basis of the brightness data that reflects the variation of the circumferential brightness. Accordingly, the brightness of the display apparatus is decreased.

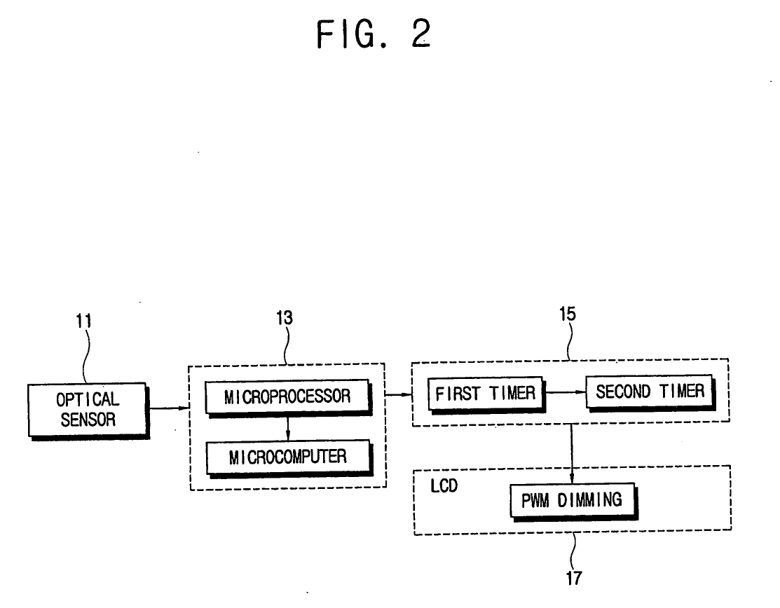

As shown in FIG. 2, the controller 13 comprises a microprocessor and a microcomputer.

The microprocessor calculates the criterion brightness data on a basis of the circumferential brightness detected by the optical sensor 11, and calculates the brightness data that reflects the variation of the circumferential brightness to generate a corresponding control signal. The microcomputer transfers the control signal generated by the microprocessor to the brightness adjuster 15.

The brightness adjuster 15 comprises a first timer and a second timer, and transfers a pulse width modulation (PWM) control signal to the displayer 17 to adjust the brightness of the displayer 17.

The first timer generates a specified pulse signal. The second timer adjusts a duty ratio of the pulse signal on a basis of the control signal transferred from the microcomputer.

The displayer 17, such as a liquid crystal display (LCD), comprises a lamp, and an inverter.

The inverter receives the PWM control signal from the brightness adjuster 15 to adjust an on/off-time of the lamp. Herein, the inverter elongates the on-time of the lamp as the duty ratio of the pulse signal received from the brightness adjuster 15 increases. Accordingly, the displayer 17 is brightened.

As an example, when the circumferential brightness detected by the optical sensor 11 exceeds the particular brightness corresponding to the criterion brightness data, the microprocessor generates a control signal corresponding to the criterion brightness data. Herein, the microcomputer transfers the control signal to the brightness adjuster 15. The brightness adjuster 15 generates a specified pulse signal of a maximum duty ratio through the first timer and the second timer and transfers the pulse signal to the displayer 17. Also, the displayer 17 outputs the maximum brightness as the on-time of the lamp is maximized by the inverter receiving the specified pulse signal of the maximum duty ratio.

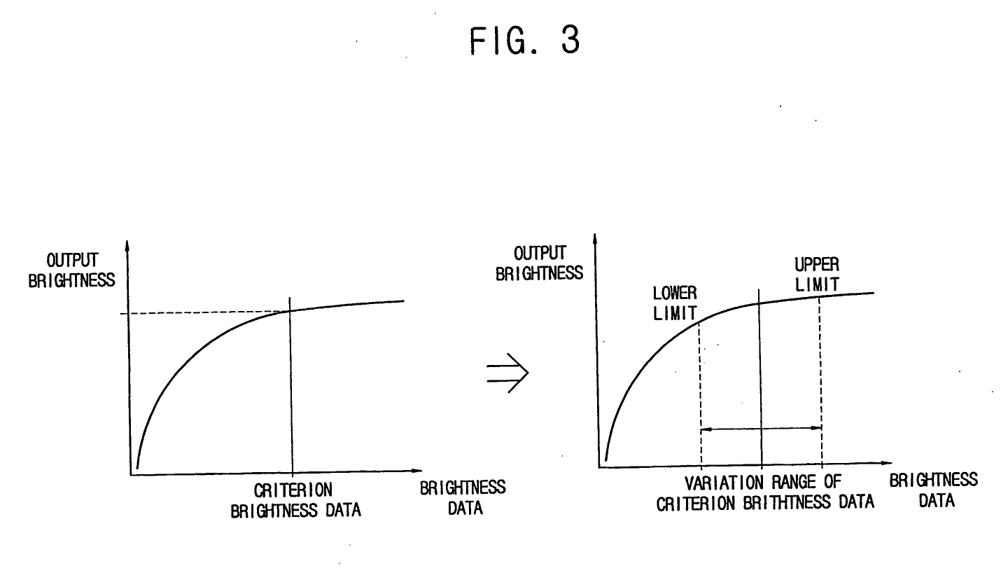

Accordingly, as shown in FIG. 3, the display apparatus according to the embodiment of the present invention calculates the criterion brightness data on a basis of the actual circumferential brightness, not like a conventional display apparatus that has a specified criterion brightness data fixed previously. The criterion brightness data has the upper and lower limits.

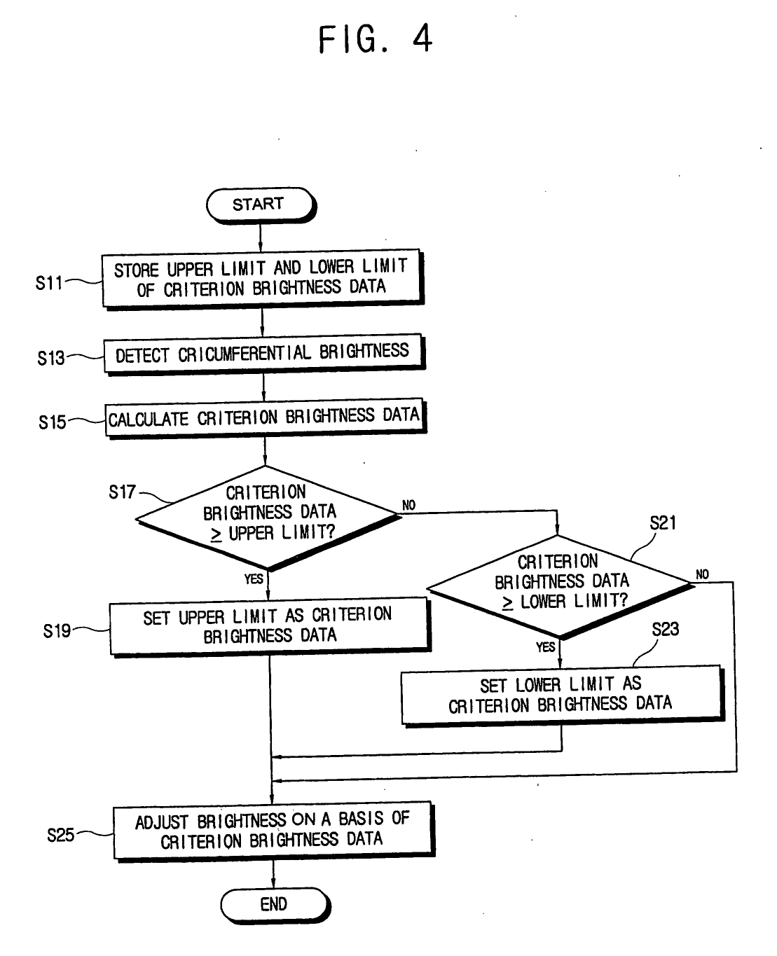

Hereinbelow, a control flow of the display apparatus according to the disclosed embodiment of the present invention will be described with concurrent reference to FIGS. 1 and 4.

At operation S11, the upper and lower limits of the criterion brightness data to enable the displayer 17 to output the maximum brightness are stored.

The optical sensor 11 detects the circumferential brightness at operation S13, while the controller 13 calculates the criterion brightness data of the displayer 17 on a basis of the circumferential brightness detected by the optical sensor 11 at operation S15.

The controller 13 calculates the average value of the circumferential brightness detected by the optical sensor 11 during a specified time to calculate the criterion brightness data. Also, the controller 13 may calculate a new criterion brightness data by reflecting the brightness data corresponding to a current circumferential brightness on a former criterion brightness data stored in the storage area in the controller 13 or in the separate memory. Various methods may be employed in calculating the criterion brightness data that reflects the actual circumferential brightness.

The controller 13 calculates the brightness data of the displayer 17 according to the variation of the circumferential brightness detected by the optical sensor 11 on a basis of the criterion brightness data. Also, the controller 13 controls the brightness adjuster 15 to adjust the brightness of the displayer 17 according to the brightness data at operation S25.

The controller 13 adjusts the brightness of the displayer 17 by setting the criterion brightness data as the upper limit (S19) when the criterion brightness data calculated by the controller 13 exceeds the upper limit (S17) stored previously at operations S19 and S25.

Also, the controller 13 adjusts the brightness of the displayer 17 by setting the criterion brightness data as the lower limit (S23) the criterion brightness data calculated by the controller 13 is below the lower limit (S21) stored previously at operations S23 and S25.

As described above, the disclosed embodiment of the present invention provides a display apparatus and a control method thereof capable of adjusting the brightness on a basis of the actual circumferential brightness.

Although an embodiment of the present invention has been shown and described, the present invention is not limited to the described embodiment. Instead, it would be appreciated by those skilled in the art that changes may be made in the embodiment without departing from the principles and spirit of the invention, the scope of which is defined by the claims and their equivalents.

1. A display apparatus comprising a displayer which displays a picture and a brightness adjuster which adjusts a brightness of the displayer, further comprising:
an optical sensor detecting circumferential brightness; and
a controller calculating criterion brightness data of the displayer on a basis of the circumferential brightness, and calculating brightness data of the displayer according to a variation of the circumferential brightness on a basis of the criterion brightness data so as to control the brightness adjuster to adjust the brightness of the displayer according to the brightness data.

2. The display apparatus of claim 1, wherein the criterion brightness data of the displayer has an upper limit and a lower limit, and
wherein the controller adjusts the brightness of the displayer on a basis of criterion data of the upper limit when the criterion brightness data exceeds the upper limit and on the basis of criterion data of the lower limit when the criterion brightness data is below the lower limit.

3. The display apparatus of claim 1, wherein the criterion brightness data is data with which the displayer outputs maximum brightness.

4. The display apparatus of claim 1, wherein the controller calculates the criterion brightness data on a basis of an average value of the circumferential brightness detected during a specified time.

5. The display apparatus of claim 2, wherein the controller calculates the criterion brightness data on a basis of an average value of the circumferential brightness detected during a specified time.

6. The display apparatus of claim 3, wherein the controller calculates the criterion brightness data on a basis of an average value of the circumferential brightness detected during a specified time.

7. The display apparatus of claim 1, further comprising an optical sensor, wherein the controller controls the brightness adjuster to output the maximum brightness of the displayer on a basis of the criterion brightness data when the circumferential brightness detected by the optical sensor is identical to or above a particular brightness corresponding to the criterion brightness data.

8. The display apparatus of claim 1, wherein the controller calculates the brightness data linearly reduced by as much as the variation of the circumferential brightness on a basis of the criterion brightness data.

9. The display apparatus of claim 1, wherein the controller controls the brightness adjuster so as to adjust the brightness of the displayer on a basis of the brightness data that reflects the variation of the circumferential brightness.

10. The display apparatus of claim 1, further comprising:
an optical sensor, wherein the controller includes a storage part storing a sampling time during which the optical sensor extracts samples out of the detected circumferential brightness, the number of samples extracted out of the circumferential brightness, and a sampling period with which the samples are extracted out of the circumferential brightness for updating the brightness data; and
a memory which stores a sampling time during which an optical sensor extracts samples out of the detected circumferential brightness, the number of samples extracted out of the circumferential brightness, and a sampling period with which the samples are extracted out of the circumferential brightness for updating the brightness data.

11. The display apparatus of claim 1, wherein the controller includes a mircoprocessor calculating the criterion brightness data on a basis of the circumferential brightness detected by an optical sensor and the brightness data reflecting the variation of the circumferential brightness to generate a corresponding control signal, and a microcomputer transferring the control signal generated by the microprocessor to the brightness adjuster.

12. The display apparatus of claim 11, wherein the brightness adjuster includes a first timer and a second timer, and transfers a pulse width modulation (PWM) control signal to the displayer to adjust the brightness of the displayer.

13. The display apparatus of claim 12, wherein the first timer generates a specified pulse signal.

14. The display apparatus of claim 12, wherein the second timer adjusts a duty ratio of the pulse signal on a basis of the control signal transferred from the microcomputer.

15. A control method of a display apparatus comprising a displayer which displays a picture and a brightness adjuster which adjusts brightness of the displayer, further comprising:
detecting circumferential brightness;
calculating a criterion brightness data on a basis of the detected circumferential brightness;
calculating brightness data according to a variation of the circumferential brightness on a basis of the criterion brightness data; and
adjusting the brightness of the displayer with the brightness adjuster according to the calculated brightness data.

16. The control method of claim 15, wherein the criterion brightness data has an upper limit and a lower limit, and wherein the brightness of the displayer is adjusted on a basis of criterion data of the upper limit when the criterion brightness data exceeds the upper limit and on the basis of criterion data of the lower limit when the criterion brightness data is below the lower limit.

17. The control method of claim 15, wherein the criterion brightness data is data with which the displayer outputs maximum brightness.

18. The control method of claim 15, wherein the calculating the criterion brightness data on a basis of the detected circumferential brightness includes calculating the criterion brightness data on a basis of an average value of the circumferential brightness detected for a specified time.

19. The control method of claim 16, wherein the calculating the criterion brightness data on a basis of the detected circumferential brightness includes calculating the criterion brightness data on a basis of an average value of the circumferential brightness detected for a specified time.

20. The control method of claim 17, wherein the calculating the criterion brightness data on a basis of the detected circumferential brightness includes calculating the criterion brightness data on a basis of an average value of the circumferential brightness detected for a specified time.

21. The control method of claim 15, wherein the calculating the criterion brightness data includes adding brightness data corresponding to a current circumferential brightness to stored former criterion brightness data.
